(19) United States
(12) Patent Application Publication
(10) Pub. No.: US 2008/0026739 A1
(43) Pub. Date: Jan. 31, 2008

(54) Method for determining mobile service coverage of a remote destination

(76) Inventors: David S. Benco, Winfield, IL (US); Kevin J. Overend, Elmhurst, IL (US); Baoling S. Sheen, Naperville, IL (US); Sandra Lynn True, St .Charles, IL (US); Kenneth J. Voight, Sugar Grove, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/494,118

(22) Filed: Jul. 27, 2006

(51) Int. Cl. H04M 3/00

(52) U.S. Cl. 455/419

(57) ABSTRACT

The present invention provides a method for determining mobile service coverage for a mobile unit for a remote destination. A communication system receives a request for mobile service coverage for a remote destination from a mobile unit. The communication system determines if mobile service coverage is available for the mobile unit at the remote destination.

### FIELD OF THE INVENTION

The present invention relates generally to communication systems, and more particularly to roaming within mobile communication systems.

### BACKGROUND OF THE INVENTION

Wireless Service Providers provide service to subscribers. The service is typically provided in defined service areas. As much as Wireless Service Providers try to provide as broad coverage as possible to their subscribers, no service provider provides service everywhere.

One way that Wireless Service Providers provide an effective increased service area to subscribers is by entering into arrangements with other service providers. These agreements allow users to utilize the equipment and services of a wireless system that is not their home wireless system when located within the service area served by the non-home service provider. This arrangement, commonly referred to as “roaming,” allows subscribers to use their mobile unit outside of the coverage area of their home system.

One problem for mobile subscribers is determining in advance whether mobile service will be provided when the mobile unit is roaming. If service is not provided by the Wireless Service Provider at the remote destination, the mobile user can make alternate arrangements prior to or while traveling. However, if the mobile user does not become aware of the lack of coverage until arriving at the remote location, the user may be unable to make appropriate arrangements.

Therefore, a need exists for a method for allowing a mobile unit to know if mobile service will be provided at a remote location prior to the mobile unit being located in the remote location.

### BRIEF SUMMARY OF THE INVENTION

The present invention provides a method for determining real-time mobile service coverage for a mobile unit for a remote destination, usually in response to a request received from the mobile unit. The present invention provides mobile subscribers with convenient access and accurate coverage information, which is based on real-time cell locations and remote destination service coverage requests.

In accordance with an exemplary embodiment, a mobile unit 107 requests coverage information for a remote destination 117. The request can be accomplished via soft-key, dial-in, calling a customer service representative of the wireless service provider, via a computer, or by any other suitable means.

After verifying that mobile unit 107 has subscribed to the remote destination service coverage feature, communication system 100 prompts the user of mobile unit 107 to enter remote destination information. The remote destination can be an address of the remote destination or the street address of the destination, a town name, a zip code, an intersection, a landmark, a building name, an airport, or any other indication of a geographical location.

Communication system 100 locates remote destination 117, preferably utilizing mapping software. The mapping software preferably converts the entered information into GPS coordinates of remote destination 117.

Communication system 100 determines coverage information for remote destination 117. This is preferably accomplished by determining if there are networked cells in the area that can provide coverage at remote destination 117. In an exemplary embodiment, communication system 100 makes the determination by comparing the GPS location of a base station with the GPS location of remote destination 117.

Communication system 100 provides coverage information to mobile unit 107 by sending the coverage information to mobile unit 107. This can be accomplished by utilizing SMS or via a screen display. The coverage information can be displayed on mobile unit 107 as a series of bars, wherein an increasing number of bars indicates increased wireless signal strength within remote destination 117. The information provided to mobile unit can be text or graphical and can either be sent to mobile unit 107 or to another device indicated by a user of mobile unit 107.

Communication system 100 can also provide additional information to requesting mobile unit 107. For example, communication system 100 can provide rate information to mobile unit 107. Additionally, communication system 100 can provide information about the coverage provided at sites adjacent to remote destination 117.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for determining mobile service coverage for a mobile unit for a remote destination in accordance with an exemplary embodiment of the present invention.

### DETAILED DESCRIPTION OF THE INVENTION

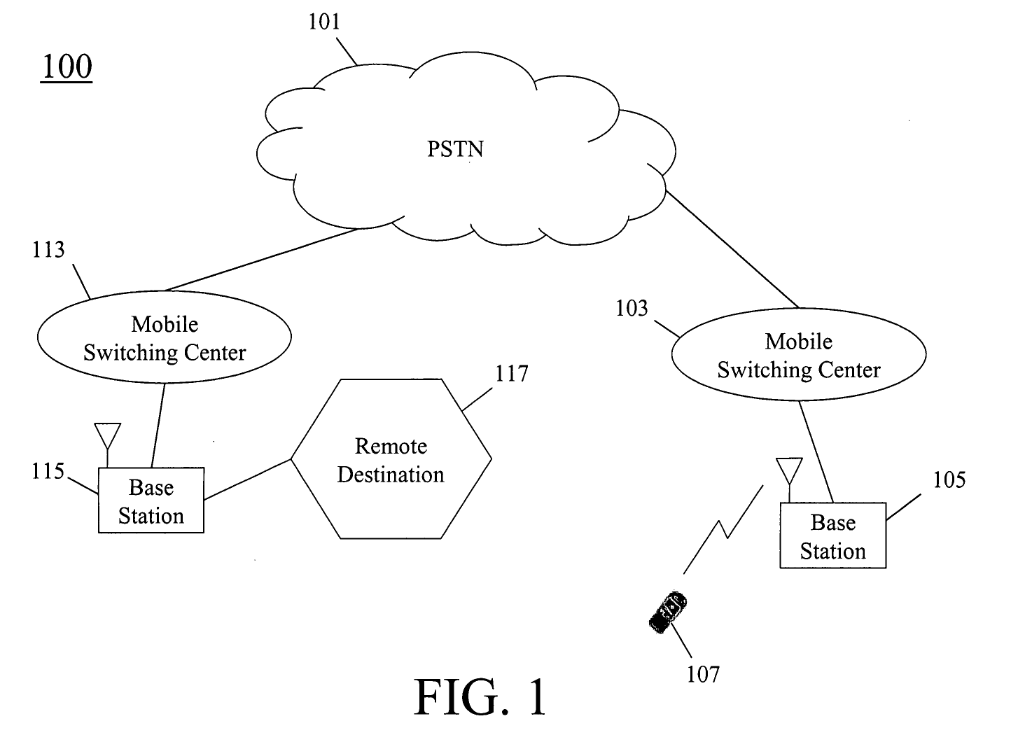

FIG. 1 depicts a communication system 100 in accordance with an exemplary embodiment of the present invention. Communication system 100 includes Public Switched Telephone Network (PSTN) 101, Mobile Switching Center (MSC) 103, another Mobile Switching Center (MSC) 113, base station 105, base station 115, and requested destination 117. Mobile unit 107 is in communication with base station 105.

PSTN 101 is an international telephone network that provides telephony service to users connected to PSTN 101. PSTN 101 provides the ability for landline users to place and receive calls within communication system 100.

MSC 103 connects PSTN 101 to the wireless communication system serviced by MSC 103. MSC 103 is preferably responsible for compiling call information for billing and handing off calls from one cell to another. In an exemplary embodiment, MSC 103 is a CDMA MSC. MSC 103 provides control for base stations, such as base station 105. It should be understood that in a typical wireless communication system, MSC 103 would control a plurality of base stations, although FIG. 1 depicts only one base station for clarity.

Base station 105 is responsible for communicating over the air with mobile units that are located within a cell area covered by base station 105. Base station 105 completes calls with PSTN 101 utilizing MSC 103. In the exemplary embodiment depicted in FIG. 1, base station 105 is communicating over the air with mobile unit 107. It should be understood that, although FIG. 1 only depicts one mobile unit 107, a typical wireless base station services a plurality of wireless units at one time. In an exemplary embodiment, base station 105 is a CDMA base station and mobile unit 107 is a CDMA mobile unit.

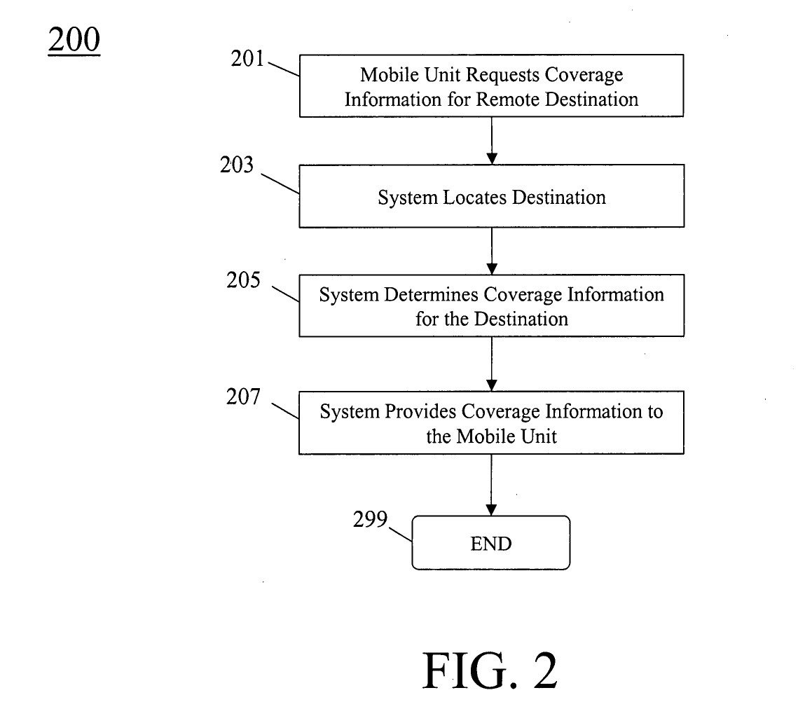

FIG. 2 depicts a flowchart 200 of a method for determining mobile service coverage for a mobile unit for a remote destination in accordance with an exemplary embodiment of the present invention. In accordance with an exemplary embodiment, the communication system provides service coverage information to a mobile unit based upon a request received from the mobile unit. This is preferably accomplished via an optional feature that a subscriber can subscribe to for a fee.

Mobile unit 107 requests (201) coverage for remote destination 117. In accordance with an exemplary embodiment, a user of mobile unit 107 initiates the determination of remote service coverage utilizing mobile device 107. This can be accomplished via soft-key or dial-in. In an alternate exemplary embodiment, mobile unit 107 can request coverage by calling a customer service representative of the wireless service provider or via a computer, such as by sending an email or accessing a website. In a further exemplary embodiment, the user can request coverage utilizing a speech-to-text converter or can verbally convey the remote location to an operator who keys the remote location information.

After verifying that mobile unit 107 has subscribed to the remote destination service coverage feature, communication system 100 prompts the user of mobile unit 107 to enter remote destination information. In a first exemplary embodiment, mobile unit 107 sends an address of the remote destination to communication system 100. The address can include the street address of the destination, a town name, a zip code, an intersection, a landmark, a building name, an airport, or any other indication of a geographical location.

Communication system 100 locates (203) remote destination 117. In accordance with an exemplary embodiment, the communication system utilizes mapping software to locate remote destination 117. The mapping software preferably converts the entered information into GPS coordinates of remote destination 117.

Communication system 100 determines (205) coverage information for remote destination 117. In the scenario where mobile unit 107 may or may not subscribe to the remote destination service coverage feature, communication system 100 preferably verifies whether mobile unit 107 has subscribed to a remote destination service coverage feature. If mobile unit 107 has subscribed, communication system 100 determines if there are networked cells in the area that can provide coverage at remote destination 117. In an exemplary embodiment, communication system 100 makes the determination by comparing the GPS location of a base station with the GPS location of remote destination 117.

In an exemplary embodiment, communication system 100 determines if a system provides cellular coverage for remote destination 117. In an alternate exemplary embodiment, communication system 100 determines if there is mobile service coverage at remote destination 117 based on the current state of the wireless equipment located at remote destination 117. For example, the present invention can use the status of the remote cellular system. In this scenario, communication system 100 can alert mobile unit 107 to the current or future working status at remote destination 117.

Communication system 100 provides (207) coverage information to mobile unit 107. In an exemplary embodiment, communication system 100 sends the coverage information to mobile unit 107 utilizing SMS (short message service). In an alternate exemplary embodiment, communication system 100 sends the coverage information to mobile unit 107 via screen display. The coverage information can be displayed on mobile unit 107 as a series of bars, wherein an increasing number of bars indicates increased wireless signal strength within remote destination 117. The information provided to mobile unit can be text or graphical and can either be sent to mobile unit 107 or to another device indicated by a user of mobile unit 107.

Communication system 100 can also provide additional information to requesting mobile unit 107. For example, communication system 100 can provide rate information to mobile unit 107. Additionally, communication system 100 can provide information about the coverage provided at sites adjacent to remote destination 117.

While this invention has been described in terms of certain examples thereof, it is not intended that it be limited to the above description, but rather only to the extent set forth in the claims that follow.

We claim:

1. A method for determining mobile service coverage for a mobile unit for a remote destination, the method comprising:
receiving a request for mobile service coverage for a remote destination from a mobile unit; and
determining if mobile service coverage is available for the mobile unit at the remote destination.

2. A method for determining mobile service coverage for a mobile unit for a remote destination in accordance with claim 1, wherein the step of receiving a request for mobile service coverage for a remote destination from a mobile unit comprises receiving a soft key request from the mobile unit.

3. A method for determining mobile service coverage for a mobile unit for a remote destination in accordance with claim 1, wherein the step of receiving a request for mobile service coverage for a remote destination from a mobile unit comprises receiving a dial in request from the mobile unit.

4. A method for determining mobile service coverage for a mobile unit for a remote destination in accordance with claim 1, wherein the step of receiving a request for mobile service coverage for a remote destination from a mobile unit comprises receiving a request at a customer service representative.

5. A method for determining mobile service coverage for a mobile unit for a remote destination in accordance with claim 1, wherein the step of receiving a request for mobile service coverage for a remote destination from a mobile unit comprises receiving a request utilizing a speech-to-text converter from the mobile unit.

6. A method for determining mobile service coverage for a mobile unit for a remote destination in accordance with claim 1, further comprising the step of verifying that the mobile unit has subscribed to a remote destination service coverage feature prior to the step of determining.

7. A method for determining mobile service coverage for a mobile unit for a remote destination in accordance with claim 1, wherein the request includes an address of the remote destination.

8. A method for determining mobile service coverage for a mobile unit for a remote destination in accordance with claim 1, wherein the request includes a town name of the remote destination.

9. A method for determining mobile service coverage for a mobile unit for a remote destination in accordance with claim 1, wherein the request includes a zip code of the remote destination.

10. A method for determining mobile service coverage for a mobile unit for a remote destination in accordance with claim 1, wherein the request includes an intersection of the remote destination.

11. A method for determining mobile service coverage for a mobile unit for a remote destination in accordance with claim 1, wherein the request includes a landmark of the remote destination.

12. A method for determining mobile service coverage for a mobile unit for a remote destination in accordance with claim 1, wherein the request includes a building name of the remote destination.

13. A method for determining mobile service coverage for a mobile unit for a remote destination in accordance with claim 1, wherein the request includes an airport of the remote destination.

14. A method for determining mobile service coverage for a mobile unit for a remote destination in accordance with claim 1, wherein the step of determining if mobile service coverage is available for the mobile unit at the remote destination comprises utilizing mapping software to locate remote destination.

15. A method for determining mobile service coverage for a mobile unit for a remote destination in accordance with claim 1, wherein the step of determining if mobile service coverage is available for the mobile unit at the remote destination comprises determining GPS coordinates of the remote destination.

16. A method for determining mobile service coverage for a mobile unit for a remote destination in accordance with claim 15, wherein the step of determining if mobile service coverage is available for the mobile unit at the remote destination comprises comparing the GPS coordinates of the remote destination with GPS coordinates of a base station.

17. A method for determining mobile service coverage for a mobile unit for a remote destination in accordance with claim 1, wherein the step of determining if mobile service coverage is available for the mobile unit at the remote destination comprises determining if wireless equipment located at the remote destination is currently operational.

18. A method for determining mobile service coverage for a mobile unit for a remote destination in accordance with claim 1, the method further comprising the step of sending an indication of the mobile service coverage to the mobile unit utilizing SMS (short message service).

19. A method for determining mobile service coverage for a mobile unit for a remote destination in accordance with claim 1, the method further comprising the step of sending an indication of the mobile service coverage to a device specified by the mobile unit.

20. A method for determining mobile service coverage for a mobile unit for a remote destination in accordance with claim 1, the method further comprising the step of sending an indication of the coverage provided by cellular sites that are adjacent to the remote destination.
